(19) United States
(12) Patent Application Publication
(10) Pub. No.: US 2026/0339482 A1
(43) Pub. Date: Oct. 29, 2026

(54) TECHNIQUES TO SUPPORT CONTEXT SHARING WITH ARTIFICIAL INTELLIGENCE SYSTEMS

(71) Applicant: Here Enterprise Inc., New York, NY (US)

(72) Inventors: Steven Mocarski, Yardley, PA (US); Gavin Lauchlan, Ayr (GB); Chuck Doerr, New York, NY (US); Brandon Waring, New York, NY (US); John Mandia, New York, NY (US)

(21) Appl. No.: 19/662,723

(22) Filed: Apr. 29, 2026

Related U.S. Application Data
(60) Provisional application No. 63/797,000, filed on Apr. 29, 2025.

(51) Int. Cl. G06F 3/04817; G06F 16/583; G06F 40/186

(52) U.S. Cl. CPC G06F 3/04817; G06F 16/5846; G06F 40/186

(57) ABSTRACT

A plurality of applications accessed via a composite user interface (UI) of a resource interface component (RIC) are identified. A first UI of the composite UI interfaces with a first application of the plurality of applications and a second UI of the composite UI interfaces with a second application of the plurality of applications. A processing device extracts first context data from first current content obtained via the first application and presented via the first UI and second context data from second current content obtained via the second application and presented via the second UI. Input for an artificial intelligence (AI) model is generated based on the first context data and the second context data.

### CROSS-REFERENCE TO RELATED APPLICATIONS

This application claims priority to U.S. Provisional Application No. 63/797,000 filed Apr. 29, 2025, which is incorporated herein by reference in its entirety.

### BACKGROUND

In the field of human-computer interaction, a user interface (UI) is a space where interactions between users and computers occur. Typically, the goal of the interactions is to allow effective operation and control of the computer from the user end to perform a task, while the computer simultaneously feeds back information that aids the decision making process of the user. In some scenarios, a user may need various pieces of information from different resources (e.g., applications, data stores, etc.) to perform a task. Accordingly, a user may utilize multiple UIs to interact with multiple resources to acquire the various pieces of information to perform a task. Oftentimes, the various pieces of information may include contextual data. Contextual data may refer to, or include, the information and circumstances that form the setting for an event, statement, or idea.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 illustrates operating environment for supporting context sharing with an AI system according to some embodiments of the present disclosure.

FIG. 2 illustrates various interactions between and operation of a user, an AI center module, and an AI system according to some embodiments of the present disclosure.

FIG. 3 illustrates various aspects of sharing context data with AI systems according to some embodiments of the present disclosure.

FIG. 4 illustrates various aspects of interactions associated with sharing context with an AI system according to some embodiments of the present disclosure.

FIG. 5 illustrates various aspects of a RIC in conjunction with an AI system according to some embodiments of the present disclosure.

FIG. 6 illustrates example interactions between an AI UI, an AI center module, and an AI system according to some embodiments of the present disclosure.

FIG. 7 illustrates an exemplary view of a composite UI according to some embodiments of the present disclosure.

FIG. 8 illustrates a flow diagram of a method for supporting context sharing with AI systems according to some embodiments of the present disclosure.

FIG. 9 illustrates a block diagram of an example system for supporting context sharing with AI systems according to some embodiments of the present disclosure.

FIG. 10 illustrates a block diagram of an example system according to some embodiments of the present disclosure.

FIG. 11 illustrates exemplary aspects of a communications architecture according to some embodiments of the present disclosure.

### DETAILED DESCRIPTION

The following description sets forth numerous specific details such as examples of specific systems, components, methods, and so forth, in order to provide a good understanding of various embodiments of the techniques described herein for context sharing between various resources (e.g., applications) accessed via a composite UI of a resource interface component (RIC). It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Embodiments described hereby provide an AI center module that enables a resource interface component (e.g., browser) to let users ask questions to AI based on one or more resources (e.g., applications and websites) they have open in the resource interface component (RIC). Many embodiments enable secure sharing of context from a set of active views to an independently configured AI model. In various embodiments, only information from permissioned views (e.g., UIs in a composite UI) is shared, ensuring sensitive or restrict content remains private.

Context drives workflows and digital context is increasingly important for AI enabled tools. User often define a task in terms of one or more application groupings (referred to as Supertabs) aimed at completing this, and this disclosure elegantly ties together a task without any AI specific knowledge.

Additionally, embodiments of the AI center module solve several technical challenges in reading the content, such as from websites. Existing approaches to gather context across various websites are ineffective because websites are not always built to be understandable programmatically. To provide the best AI context while being conscious of privacy or model-based token limitations the techniques and components disclosed hereby are able to select the best available method of providing the content to an AI model.

In many embodiments, the AI center module generally includes an administrative portion, an application programming interface (API), and an end user facing AI center. The administrative portion may manage which applications are able to participate in context sharing. The API may derive context of the views that are appropriately permissioned. The end user facing AI center may utilize the API to derive context that it provides to a separate AI model to deliver insights to users.

In these and other ways, components/techniques described hereby may provide many technical advantages for supporting context sharing with AI systems. Therefore, the computer-based techniques of the current disclosure improve the functioning of context sharing techniques, resulting in better performance, improved capabilities, and improved user experiences as compared to conventional approaches. Accordingly, embodiments disclosed hereby can be practically utilized to improve the functioning of a computer and/or to improve a variety of technical fields including context sharing, composite UIs, resource interface components, user experience, human-machine interfaces, and AI systems.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

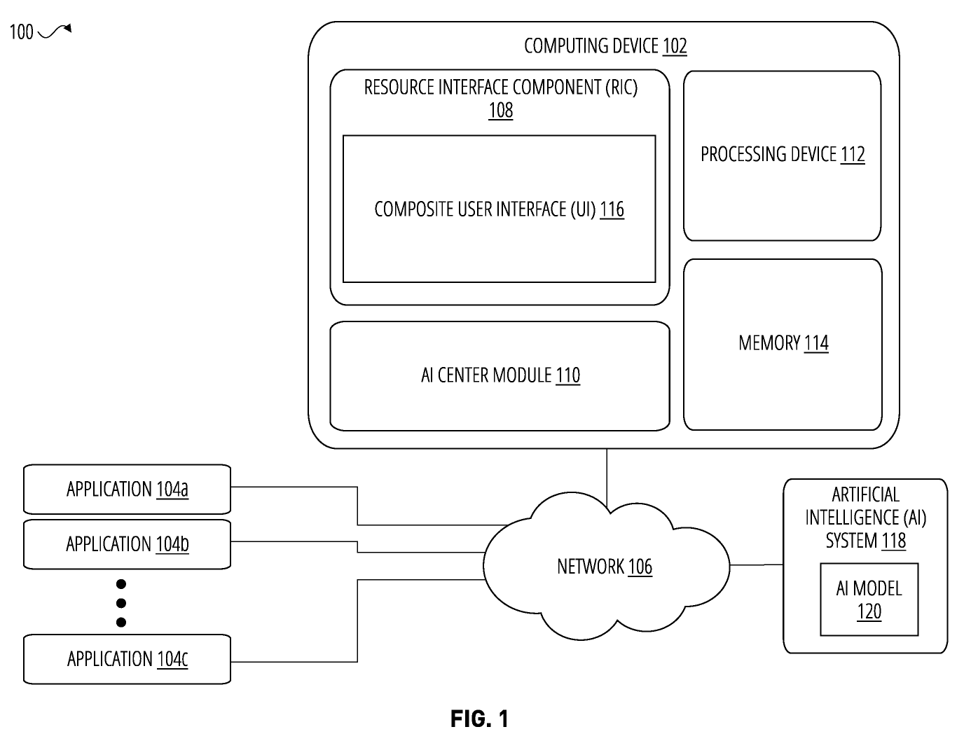

FIG. 1 illustrates an operating environment 100 for supporting context sharing with an AI system 118 according to some embodiments. Operating environment 100 includes a computing device 102, a plurality of applications 104a, 104b, 104c (collectively referred to as resources 106), the AI system 118, and a network 106. The computing device 102 includes a resource interface component (RIC) 108, an AI center module 110, a processing device 112, and a memory 114. The AI system 118 includes an AI model 120. In various embodiments, the RIC 108 may facilitate access to a plurality of resources (e.g., applications 106) via a composite UI 116. In many embodiments, the RIC 108 may operate in conjunction with the AI center module 110 to support context sharing from current content accessed via the applications 104 and presented via the composite UI 116. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, one or more of the applications 104 may be included in the computing device 102 without departing from the scope of this disclosure. In another example, the composite UI 116 may be presented on a separate computing device. Embodiments are not limited in this context.

In several embodiments, the RIC 108 operates in conjunction with the AI center module 110 to facilitate seamless integration of independent AI models (e.g., enterprise or third-party models). Further, in many embodiments, the AI center module 110 makes enterprise AI models easily accessible to users and embeds them into workflows to maximize their potential. Additional key capabilities provided include the ability for enterprises to have the flexibility to choose from various enterprise AI solutions, including commercial and enterprise models, making enterprise AI omnipresent within workflows, eliminating key adoption barriers for organizations, leveraging application context to enhance AI inputs, accessing content within groupings (e.g., supertabs) to increase speed and efficiency with which AI tasks, such as summarization, can be performed, enabling users and administrators to configure automatic generation, selection, modification, and/or population of prompts based on changes to context or content, and providing centralized controls that enable data loss prevention (DLP) for AI tools and empower security teams to determine whether or not each application can interact with the AI center module (e.g., participate in context sharing).

Context enhances the ability of AI models to provide better and more accurate answers. While existing AI solutions can get some context through back-end integrations (e.g. with email systems, CRM, etc.), application context is only available on the front-end where the user is working. Accordingly, this disclosure makes application context available securely so a user can, for example, simply ask “tell me more about this client”. The AI center module 110 automatically applies the context (e.g. the client name, identifier, etc.) which can come from a CRM application and multiple other applications that the user is currently running.

More generally, the RIC 108 may generate the composite UI 116 having a layout including a collection of display elements or user interfaces (e.g., tabs, windows, and resource interfaces displaying content) that interface with applications 104. For example, application 104a may be interacted with via a first UI of the composite UI 116, application 104b may be interacted with via a second UI of the composite UI 116, and application 104c may be interacted with via a third UI of the composite UI 116. The layout and collection of display elements may be configured in a variety of manners without departing from the scope of this disclosure. For example, the composite UI 116 may include an arbitrary layout and collection of display elements that is only limited by the capabilities of the underlying hardware. In many embodiments, the layout and collection of display elements may be configured by a user or an administrator.

In many embodiments, the AI center module 110 may be configured to extract context data from the composite UI 116 and utilize the extracted context data to generate inputs for the AI system 118. In many embodiments, the extraction of context data may be controlled based on one or more sets of permissions. For example, each of the applications 104 may be associated with a set of permissions that indicate whether or not context data may be extracted from content obtained by different ones of applications 104 and presented via composite UI 116.

The applications 104 may include or refer to various resources, web applications, portals, widgets, gadgets, and the like. More generally, an application may include or refer to a computing entity that may provide or receive data via the composite UI 116. In the illustrated embodiment, the resources 106 are communicatively coupled with the computing device 102 via a network, such as the internet. However, the resources may be communicatively coupled to the computing device 102 via any means without departing from the scope of this disclosure. For example, one or more resources may be included in the computing device 102.

It should be noted that although a single processing device 112 and a single memory 114 are depicted in the computing device 102 of FIG. 1 for simplicity, other embodiments may include multiple processing devices, storage devices, or devices. processing device 112 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. processing device 112 may also include one or more special-purpose processing devices such as an application specific integrated circuit (ASIC), a field programmable gate array (FPGA), a digital signal processor (DSP), network processor, or the like. Further details regarding supporting dynamic context sharing will be discussed below.

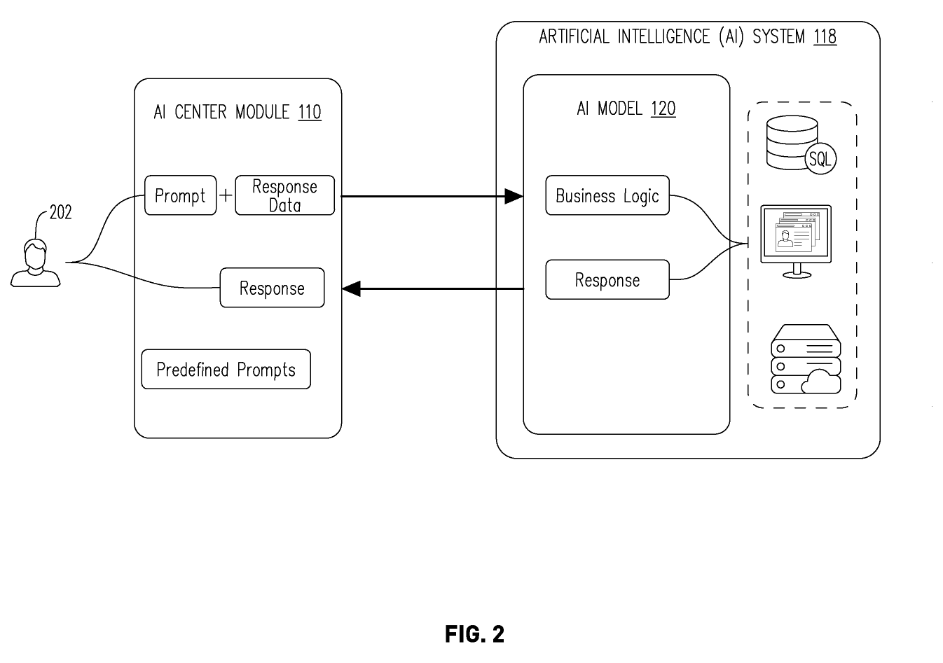

FIG. 2 illustrates various interactions between and operation of a user 202, the AI center module 110, and the AI system 118 according to some embodiments. Generally, a user 202 may provide input that causes the AI center module 110 to generate a prompt and contextual data associated with the prompt. In various embodiments, the contextual data, or context data, may be acquired from various user interfaces (e.g., of the composite UI 116). The prompt along with the context data may be passed to the AI system 118. The AI system 118 may process the prompt and contextual data via the AI model 120, various business logic, and backend resources (e.g., databases, vector stores, etc.) to generate a response. The response may be returned to the AI center module 110 and presented to the user 202 via the composite UI 116.

In various embodiments, the AI center module 110 may include various predefined and/or template prompts. For example, AI center module 110 may combine a query provided by the user 202 with one or more template prompts to generate the prompt. In some embodiments, the template prompt may be selected based on the contextual data, the applications corresponding to the contextual data, and the like. More generally, the AI center module 110 (such as via admin tool 402) may enable prompts to be configured in a variety of ways. For example, the type/format/volume of data (e.g., context data) affixed to prompts may be configured, such as via prompt augmentation. In another example, prompt follow up actions may be performed, such as to condense the response. In yet another example a library of sample, template, or reference prompts may be created or configured.

In some embodiments, the AI center module 110 may trigger additional actions, modifications, or workflows based on the response, such as type/format of rich data within/affixed to the response, interactive responses, and triggering application workflows/interoperability. For example, the AI center module 110 may replace a reference to a customer in the response with a link to a profile of the customer. In another example, a reference to a resource or application in the response may be replaced with a link to launch or view the application and/or access specific information via the application. In yet another example, a database record (e.g., user profile) may be automatically updated based on the response.

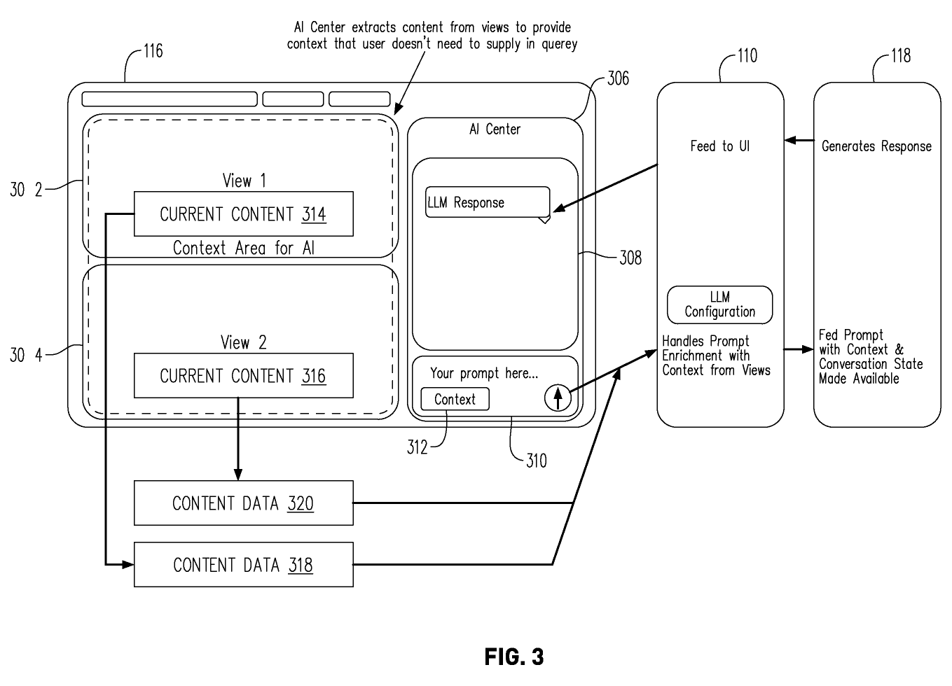

FIG. 3 illustrates various aspects of sharing context data with AI systems according to some embodiments. In the illustrated embodiment, the composite UI 116 includes a first UI 302, a second UI 304, and a third UI 306. The first UI 302 may interface with a first application, the second UI 302 may interface with a second application, and the third UI 306 may interface with the AI center module 110 (referred to as the AI UI 306 or the end user facing AI center).

In various embodiments, a user may enter a query into the query box 310 of the UI 306 and click submit. In response, first context data 318 may be extracted from current content 314 and second context data 320 may be extracted from current content 316. In many embodiments, the extraction of context data 318 and context data 320 may only occur after appropriate permissions for sharing are confirmed. The query, along with context data 318 and context data 320 may then be provided to the AI center module 110. The AI center module 110 may then handle prompt enrichment based on the context data 318 and context data 320 and/or configuration (e.g., conversation identifier or model identifier) of the AI model (e.g., large language model (LLM)). The prompt with the context and any configuration data may be fed to the AI system 118. The AI system 118 may generate a response that is returned to the AI center module 110. The AI center module 110 may then populate a dialogue box 308 of the UI 306 with the response. More generally, the dialogue box 308 may comprise a chat box that displays the conversation between the AI system and the user.

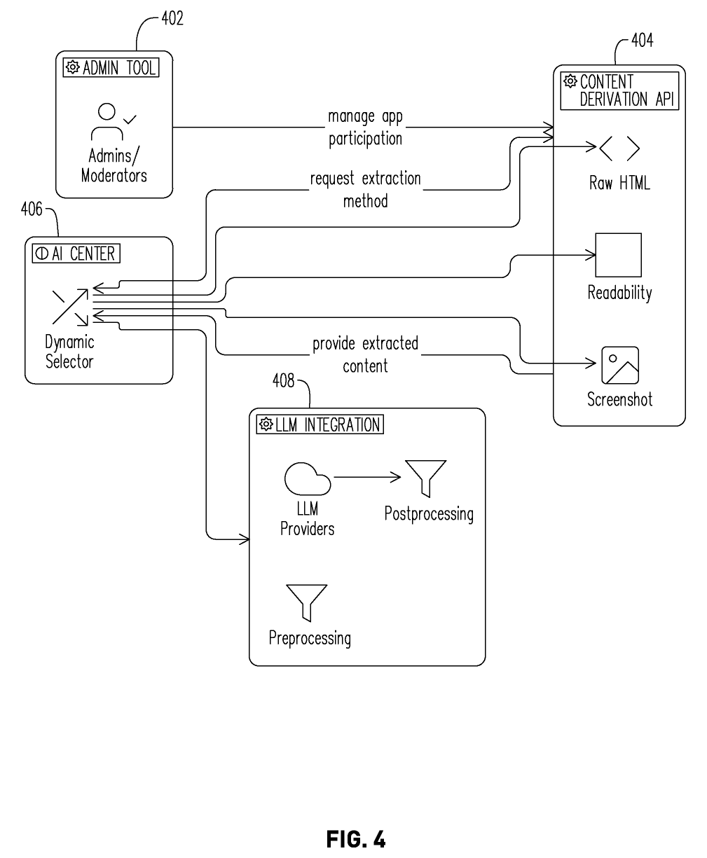

In some embodiments, the AI center module 110 may be configured, at least in part, via the UI 306. For example, a user may click context sharing settings 312 to toggle context sharing on/off. In another example, the settings for context sharing with the AI system 118 may be opened in response to clicking the context sharing settings 312. In some embodiments, these settings may enable a user to select from prompt templates, modify prompt templates, select models, select AI systems, configure sharing permissions, configure chat session retention options, and the like. In various embodiments, the settings available to a user may be based on a set of permissions associated with the user. Additionally, all settings for context sharing may be accessible via an administrator tool, as described in more detail with respect to FIG. 4.

In some embodiments, the user may be able to modify the extracted context. For example, the user may be able to delete portions of the extracted context that are not relevant. In another example, a user may be able to explicitly add content that was not extracted as context. In various embodiments, a user may be able to provide other context data. For example, a user may be able to upload a document for the AI center module 110 to utilize as context.

FIG. 4 illustrates various aspects of interactions associated with sharing context with an AI system 408 according to some embodiments. The illustrated embodiment includes an admin tool 402, a content derivation API 404, an AI center 406, and the AI system 408.

Generally, the admin tool 402 may manage which applications are able to share context. The admin tool 402 may be utilized to configure and control all settings associated with sharing context with the AI system 408. For example, the admin tool 402 may be utilized to set which applications have permission to share content with the AI system 408. In another example, the admin tool 402 may be utilized to create and/or modify template prompts. Additionally, the admin tool 402 may be utilized to create rules associated with selecting various settings or configurations. For example, the admin tool 402 may be utilized to create a rule that causes a first template prompt to be utilized when a first set of applications are being accessed via the composite UI 116 and a second template prompt to be utilized when a second set of applications are being accessed via the composite UI 116. In yet another example, the admin tool 402 may be utilized to create rules regarding which extraction type to utilize for content, such as based on the content type or associated application. In many embodiments, rules may enable users and administrators to configure automatic generation, selection, modification, and/or population of prompts based on changes to context or content.

In various embodiments, the content derivation API 404 may be utilized to derive context from content of the views that are appropriately permissioned. The content derivation API 404 may include an application programming interface (API) that facilitates different types of context data to be extracted from content. For example, the context data may include one or more of hypertext markup language (HTML), readability, and screenshots. HTML and/or raw HTML may be the most economical technique for context data extraction, but may not work in some scenarios, such as a dynamically driven page (e.g., JavaScript). Readability may utilize screen reader technology to obtain a summary in a similar way that a screen reader would for purposes of accessibility. This technique works well for fully ADA compliant resources (e.g., ADA compliant website). Screen shots may provide images of the content where appropriate to enable the AI to utilize visual cues like charts, highlights, or font headings for greater awareness. In some embodiments, the AI center and or AI system may analyze content to determine the appropriate manner or technique to utilize to extract context. In some embodiment, multiple extraction techniques may be utilized on the same content.

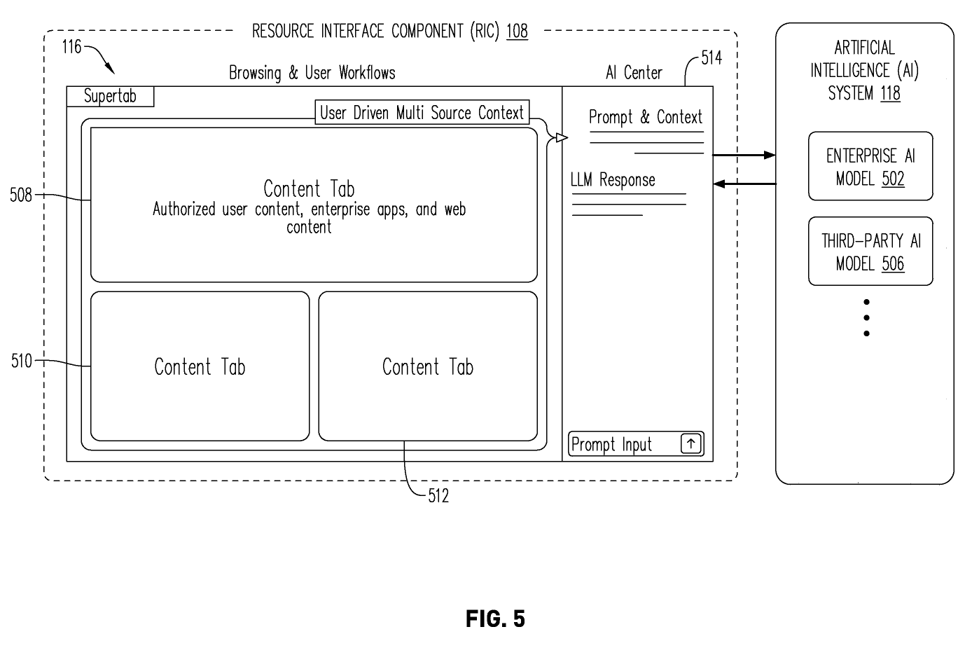

FIG. 5 illustrates various aspects of the RIC 108 in conjunction with the AI system 118 according to some embodiments. In the illustrated embodiment, the RIC 108 includes the composite UI 116 with a first application UI 508, a second composite UI 510, a third application UI 512, and an AI UI 514. The AI system 118 includes a plurality of AI models including an enterprise AI model 502 and a third-part AI model 506. In various embodiments, a prompt and context data may be provided to the AI system 118 and an LLM response may be returned from the AI system 118 and displayed in the AI UI 514. As previously mentioned, the AI system 118 may utilize a variety of types of AI models from a variety of providers.

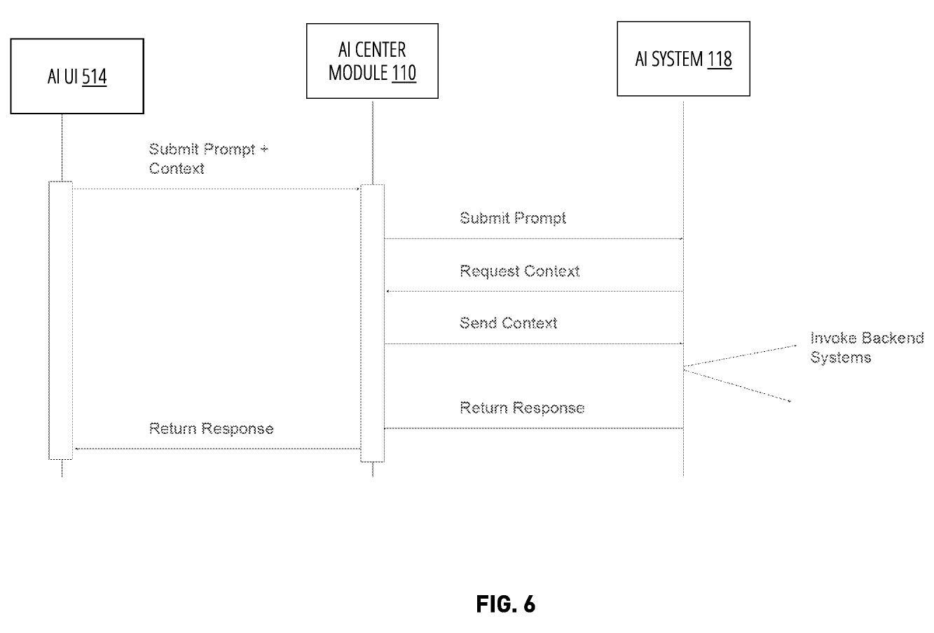

FIG. 6 illustrates example interactions between the AI UI 514, the AI center module 110, and the AI system 118 according to some embodiments.

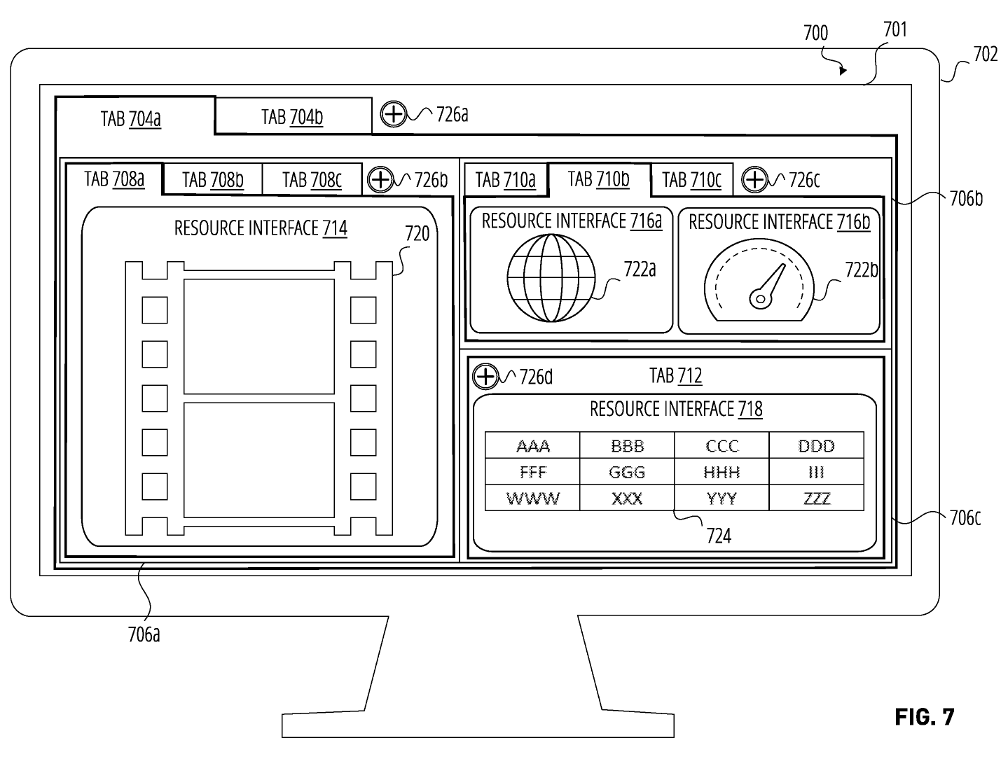

FIG. 7 illustrates an exemplary view 700 of a composite UI 701 according to some embodiments. In the illustrated embodiment, the composite UI 701 is presented via a display 702. In various embodiments, the composite UI 701 may be generated by a resource interface component (e.g., RIC 108), such as an enterprise browser application. The composite UI 701 may include a collection of tabs, windows, and resource interfaces displaying content. In embodiments described hereby, the resources corresponding to the various resource interfaces may be grouped into sharing sets, such as based on inclusion in a group of tabs, windows, interfaces, etc., referred to as a supertab. One or more components of FIG. 7 may be the same or similar to one or more other components disclosed hereby. For example, the view 700 of composite UI 701 may be the same or similar to a view of the composite UI 116. Further, aspects discussed with respect to various components in FIG. 7 may be implemented by one or more other components from one or more other embodiments without departing from the scope of this disclosure. Embodiments are not limited in this context.

The layout and collection of the tabs, windows, resource interfaces, etc. in a view of composite UI 701 may be dynamically added, removed, modified, moved, sized, configured, and customized by users to produce different composite UI views, subject to the capabilities of the underlying hardware. In various embodiments, a supertab may include an arbitrary collection of the tabs, windows, and resource interfaces in the composite UI. Further, a composite interface may include one or more supertabs and/or tabs, windows, and resource interfaces may be included in multiple supertabs. In many embodiments, context data may be extracted from content in a current, or active, super tab including content from each of the tabs, windows, resource interfaces, etc. included in the current supertab. In many such embodiments, context data may only be extracted based on permissions associated with each of the UIs and/or the interfaced entity for each of the UIs (e.g., applications).

More generally, a view of a composite UI may refer to the current collection and layout of the tabs, windows, and resource interfaces of the composite UI. In the illustrated embodiment, the view 700 of composite UI 701 includes first and second tabs 704a, 704b (collectively referred to as tabs 204) and UI element 726a. The UI element 726a may be utilized to add additional tabs. The tabs 204 may be referred to as primary tabs. In view 700, the first tab 704a is displayed and the second tab 704b is positioned behind the first tab 704a. Selection of the second tab 704b, such as based on user input, may bring the second tab 704b to the top with the first tab 704a being positioned behind the second tab 704b. Other tabs, such as tabs 708a, 708b, 708c may operate in the same or similar manner.

The first tab 704a includes first, second, and third windows 706a, 706b, 706c (collectively referred to as windows 206). The first window 706a includes first, second, and third tabs 708a, 708b, 708c (collectively referred to as tabs 208) and UI element 726b. The first tab 708a is displayed in view 700 of composite UI 701 and includes a resource interface 714 (e.g., UI 302) displaying content 720 (e.g., current content 314). The tabs 708b, 708c may include one or more additional resource interfaces displaying content. The second window 706b includes first, second, and third tabs 710a, 710b, 710c (collectively referred to as tabs 210) and UI element 726c. The second tab 708c is displayed in view 700 of composite UI 701 and includes a first resource interface 716a displaying content 722a and a second resource interface 716b displaying content 722b. The tabs 710a, 710c may include one or more additional resource interfaces displaying content. The third window 706c includes tab 712 and UI element 726d. The tab 712 is displayed in view 700 of composite UI 701 and includes resource interface 718 displaying content 724. The UI elements 726b, 726c, 726d may be the same or similar to UI element 726a and may be utilized to add additional tabs. The tabs 708, 710, 712 may be referred to as subtabs. More generally, tabs included in a primary tab (e.g., tab 704a) may be referred to as subtabs.

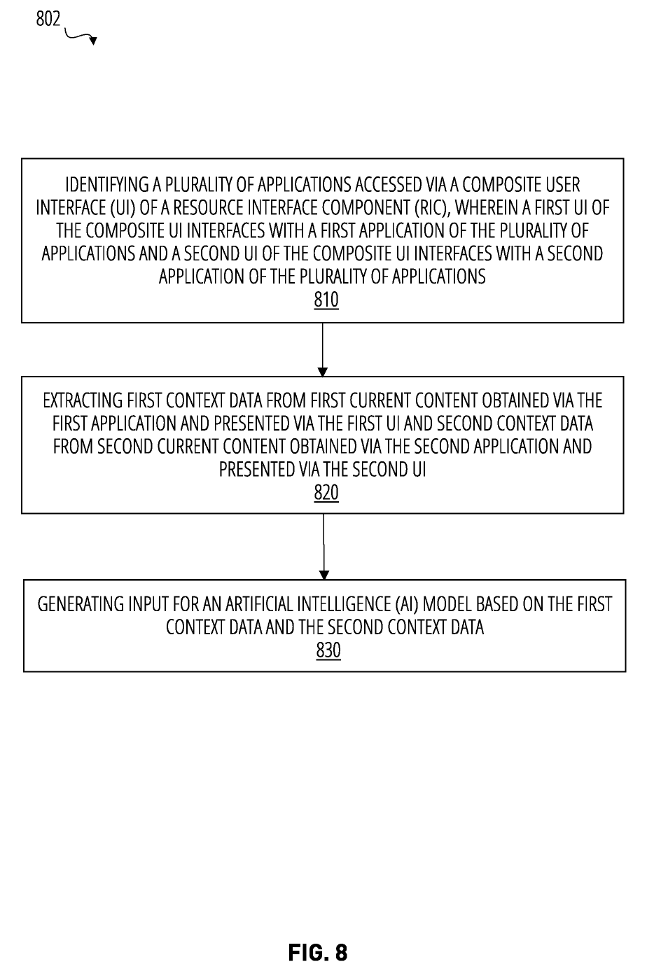

FIG. 8 is a flow diagram of a method 802 for supporting context sharing with AI systems according to some embodiments. Method 802 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 802 may be performed through the execution of RIC 108 and/or AI center module 110 by processing device 112 of FIG. 1.

With reference to FIG. 8, method 802 illustrates example functions used by various embodiments. Although specific function blocks ("blocks") are disclosed in method 802, such blocks are examples. That is, embodiments are well suited to performing various other blocks or variations of the blocks recited in method 802. It is appreciated that the blocks in method 802 may be performed in an order different than presented, and that not all of the blocks in method 802 may be performed.

Method 802 begins at block 810, where the processing logic identifies a plurality of applications accessed via a composite user interface (UI) of a resource interface component (RIC). Further, a first UI of the composite UI interfaces with a first application of the plurality of applications and a second UI of the composite UI interfaces with a second application of the plurality of applications. For example, the AI center module 110 may identify application 104a and application 104b as being accessed via composite UI 116 of RIC 108. In some embodiments, a first UI 302 of composite UI 116 may interface with application 104a and a second UI 304 of composite UI 116 may interface with application 104b.

At block 820, the processing logic extracts first context data from first current content obtained via the first application and presented via the first UI and second context data from second current content obtained via the second application and presented via the second UI. For example, AI center module 110 may extract first context data 318 from current content 314 presented via the first UI 302 and second context data 320 from current content 316 presented via the second UI 304. In some embodiments, the AI center module 110, or components thereof, may extract the first context data 318 based on a set of permissions associated with the corresponding application (e.g., application 104a) that allow context sharing from the corresponding application. Similarly, the AI center module 110, or components thereof, may extract the first context data 318 based on a set of permissions associated with the corresponding application (e.g., application 104b) that allow context sharing from the corresponding application. In various embodiments, context data may not be extracted from current content in a UI of the composite UI 116 based on permissions associated with an application that interfaces with the UI.

At block 830, the processing logic generates input for an AI model based on the first context data and the second context data. For example, the AI center module 110 may generate an input prompt for an LLM based on the first context data 318 and the second context data 320.

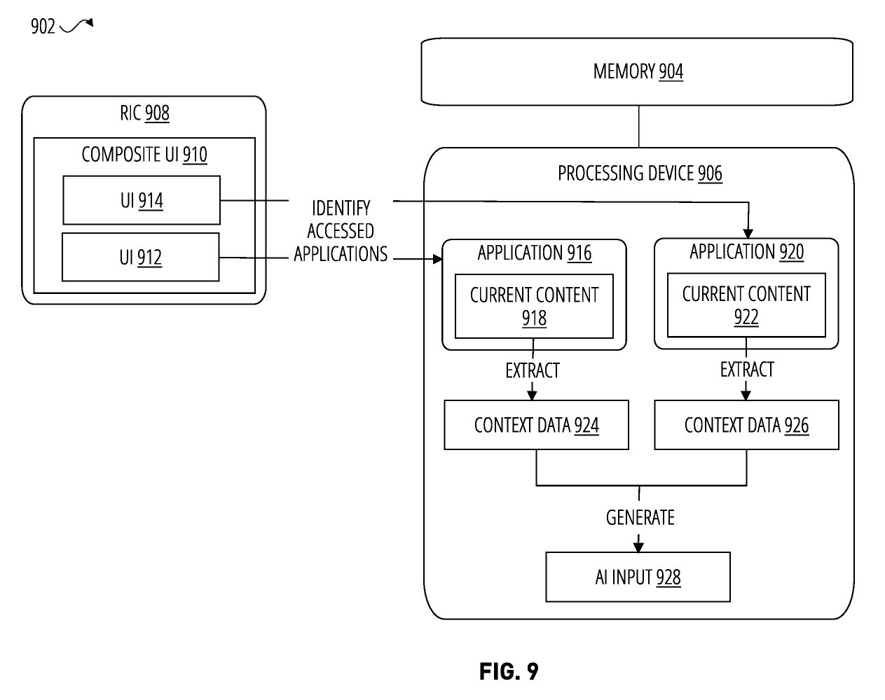

FIG. 9 illustrates a block diagram of a system 902 for supporting context sharing with AI systems according to some embodiments. In the illustrated embodiment, system 902 includes a memory 904, a processing device 906, an RIC 908 with a composite UI 910 having a first UI 912 and a second UI 914. It should be noted that some components of system 902 are shown for illustrative purposes only and are not physical components of the system 902, such as current content 918 and context data 924. One or more components of FIG. 9 may be the same or similar to one or more other components disclosed hereby. For example, processing device 906 may be the same or similar to processing device 112. Further, aspects discussed with respect to various components in FIG. 9 may be implemented by one or more other components from one or more other embodiments without departing from the scope of this disclosure. Embodiments are not limited in this context.

In system 902, the processing device 906 may identify a plurality of applications accessed via the composite UI 910 of RIC 908 including a first application 916 that interfaces with the first UI 912 of RIC 908 and a second application 920 that interfaces with a second UI 914 of RIC 908. First context data 924 may then be extracted from current content 918 obtained via the first application 916 and presented via the first UI 912 and second context data 926 may be extracted from current content 922 obtained via the second current content 918 and presented via the second UI 914. The first context data 924 and the second context data 926 may then be utilized to generate an AI input 928.

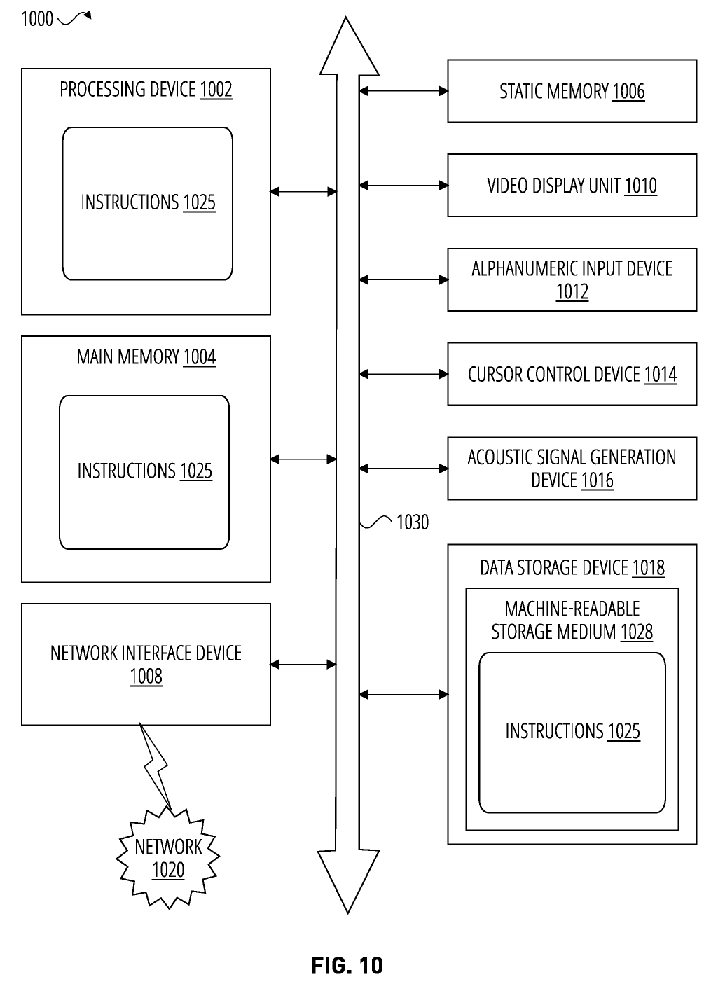

FIG. 10 is a block diagram of an example computing device 1000 that may perform one or more of the operations described herein, in accordance with some embodiments of the disclosure. Computing device 1000 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 may include a processing device 1002 (e.g., a general purpose processor, a PLD, etc.), a main memory 1004 (e.g., synchronous dynamic random access memory (DRAM), read-only memory (ROM)), a static memory 1006 (e.g., flash memory and a data storage device 1018), which may communicate with each other via a bus 1030.

Processing device 1002 may be provided by one or more general-purpose processing devices such as a microprocessor, central processing unit, or the like. In an illustrative example, processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also include one or more special-purpose processing devices such as an application specific integrated circuit (ASIC), a field programmable gate array (FPGA), a digital signal processor (DSP), network processor, or the like. The processing device 1002 may execute the operations described herein, in accordance with one or more aspects of the present disclosure, for performing the operations and steps discussed herein.

Computing device 1000 may further include a network interface device 1008 which may communicate with a network 1020. The computing device 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and an acoustic signal generation device 816 (e.g., a speaker). In one embodiment, video display unit 1010, alphanumeric input device 1012, and cursor control device 1014 may be combined into a single component or device (e.g., an LCD touch screen).

Data storage device 1018 may include a machine-readable storage medium 1028 on which may be stored one or more sets of instructions 1025 that may include instructions for a component (e.g., one or more components of RIC 108 and/or AI center module 110) for carrying out the operations described herein, in accordance with one or more aspects of the present disclosure. Instructions 1025 may also reside, completely or at least partially, within main memory 1004 and/or within processing device 1002 during execution thereof by computing device 1000, main memory 1004 and processing device 1002 also constituting computer-readable media. The instructions 1025 may further be transmitted or received over a network 1020 via network interface device 1008.

While machine-readable storage medium 1028 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

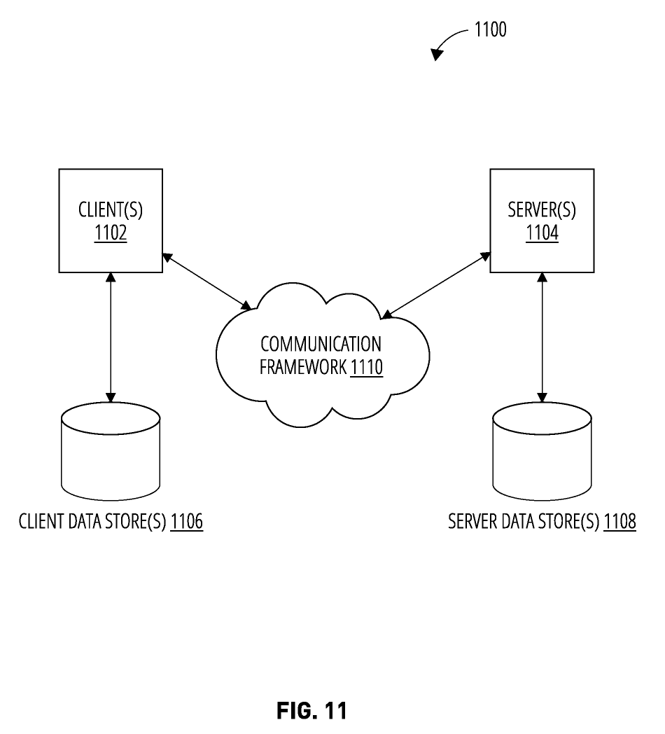

FIG. 11 is a block diagram depicting an exemplary communications architecture 1100 suitable for implementing various embodiments as previously described, such as communications between resources (e.g., applications 104) and computing device 102, for example. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 includes one or more client(s) 1102 and server(s) 1104. In some embodiments, each client 1102 and/or server 1104 may include a computing system (e.g., computing device 1000). In some embodiments, the server(s) 1104 may implement one or more devices or components, such as of applications 104 or AI system 118. In various embodiments, the client(s) 1102 may implement one or more device or components, such as of computing device 102. In many embodiments, components may be a server to some components and a client of other components. The client(s) 1102 and the server(s) 1104 are operatively connected to one or more respective client data store(s) 1106 and server data store(s) 1108 that can be employed to store information local to the respective client(s) 1102 and server(s) 1104, such as cookies and/or associated contextual information. In various embodiments, any one of server(s) 1104 may implement one or more logic flows or operations described hereby, such as in conjunction with storage of data received from any one of client(s) 1102 on any of server data store(s) 1108. In one or more embodiments, one or more of client data store(s) 1106 or server data store(s) 1108 may include memory accessible to one or more portions of components, applications, and/or techniques described hereby.

The client(s) 1102 and the server(s) 1104 may communicate information between each other using a communication framework 1110. The communication framework 1110 may implement any well-known communications techniques and protocols. The communication framework 1110 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1110 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 1102 and the server(s) 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other

Unless specifically stated otherwise, terms such as “identifying,” “extracting,” “generating,” “selecting”, “communicating”, “presenting”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms "first," "second," "third," "fourth," etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
identifying a plurality of applications accessed via a composite user interface (UI) of a resource interface component (RIC), wherein a first UI of the composite UI interfaces with a first application of the plurality of applications and a second UI of the composite UI interfaces with a second application of the plurality of applications;
extracting, by a processing device, first context data from first current content obtained via the first application and presented via the first UI and second context data from second current content obtained via the second application and presented via the second UI; and
generating input for an artificial intelligence (AI) model based on the first context data and the second context data.

2. The method of claim 1, wherein the first context data is extracted from the first current content obtained via the first application and presented via the first UI based on a first set of sharing permissions.

3. The method of claim 1, wherein a third UI of the composite UI interfaces with a third application of the plurality of applications and the method further comprises excluding extraction of third context data from the third current content obtained via the third application and presented via the third UI based on a third set of sharing permissions.

4. The method of claim 1, wherein the first context data is extracted from the first current content as hypertext markup language (HTML) and the second context data is extracted from the second current content as a screenshot.

5. The method of claim 4, further comprising:
selecting to extract the first context data as HTML based on the first current content including text; and
selecting to extract the second context data as a screen shot based on the second current content including a graphic.

6. The method of claim 1, wherein the first context data is extracted from the first current content with a screen reader.

7. The method of claim 1, wherein a third UI of the composite UI interfaces with an AI system that implements the AI model and the method further comprises generating the input for the AI model in response to a query received via the third UI.

8. The method of claim 7, further comprising:
communicating the input for the AI model to the AI system; and
presenting, via the third UI, at least a portion of a response from the AI model.

9. The method of claim 1, wherein the AI model comprises a large language model (LLM) and the input for the AI model comprises an input prompt for the LLM.

10. The method of claim 9, further comprising selecting a template prompt to utilize in generation of the input prompt based on at least one of the first application or the second application.

11. The method of claim 9, further comprising selecting a template prompt to utilize in generation of the input prompt based on at least one of the first context data or the second context data.

12. The method of claim 1, wherein the first UI comprises a first tab, a first window, or a first icon of the composite UI and the second UI comprises a second tab, a second window, or a second icon in the composite UI.

13. The method of claim 1, wherein the RIC comprises an application.

14. The method of claim 13, wherein the RIC comprises a browser.

15. The method of claim 1, wherein the RIC comprises an operating system.

16. An apparatus, comprising:
a memory; and
a processing device, operatively coupled to the memory, to:
identify a plurality of applications accessed via a composite user interface (UI) of a resource interface component (RIC), wherein a first UI of the composite UI interfaces with a first application of the plurality of applications and a second UI of the composite UI interfaces with a second application of the plurality of applications;
extract, by a processing device, first context data from first current content obtained via the first application and presented via the first UI and second context data from second current content obtained via the second application and presented via the second UI; and
generate input for an artificial intelligence (AI) model based on the first context data and the second context data.

17. The apparatus of claim 16, wherein the first context data is extracted from the first current content obtained via the first application and presented via the first UI based on a first set of sharing permissions.

18. The apparatus of claim 16, wherein a third UI of the composite UI interfaces with a third application of the plurality of applications and the processor is further to exclude extraction of third context data from the third current content obtained via the third application and presented via the third UI based on a third set of sharing permissions.

19. A non-transitory computer-readable storage medium including instructions that, when executed by a processing device, cause the processing device to:
identify a plurality of applications accessed via a composite user interface (UI) of a resource interface component (RIC), wherein a first UI of the composite UI interfaces with a first application of the plurality of applications and a second UI of the composite UI interfaces with a second application of the plurality of applications;
extract, by a processing device, first context data from first current content obtained via the first application and presented via the first UI and second context data from second current content obtained via the second application and presented via the second UI; and
generate input for an artificial intelligence (AI) model based on the first context data and the second context data.

20. The non-transitory computer-readable storage medium of claim 19, wherein the first context data is extracted from the first current content as hypertext markup language (HTML) and the second context data is extracted from the second current content as a screenshot.
